(19) United States
(12) Patent Application Publication
(10) Pub. No.: US 2008/0116736 A1
(43) Pub. Date: May 22, 2008

(54) Spinner hubcap

(76) Inventor: Isaiah Freeman, Kansas City, MO (US)

Correspondence Address: LITMAN LAW OFFICES, LTD., P.O. BOX 15035, CRYSTAL CITY STATION, ARLINGTON, VA, 22215, US

(21) Appl. No.: 12/010,266

(22) Filed: Jan. 23, 2008

Related U.S. Application Data
(63) Continuation-in-part of application No. 10/849,889, filed on May 21, 2004, now abandoned.

(51) Int. Cl. B60B 11/10

(52) U.S. Cl. 301/37.25

(57) ABSTRACT

A freely rotating hubcap is mounted onto an existing wheel using a bearing assembly that is bolted into holes tapped into the lug nuts of the wheel. Balancing weights are added to the hubcap to ensure that it easily rotates when the wheel rotates, and can continue to rotate for a short period of time after the wheel has stopped rotating.

### CROSS-REFERENCE TO RELATED APPLICATION

This application is a continuation-in-part of patent application Ser. No. 10/849,889, filed May 24, 2004.

### BACKGROUND OF THE INVENTION

1. Field of the Invention

The present invention generally relates to automobile accessories. More specifically, the present invention is drawn to freely rotating hubcaps, commonly referred to as “spinner” hubcaps.

2. Description of Related Art

The use of spinner hubcaps is well known and is well represented in the related art. However, none have been found entirely satisfactory. There is a need for a decorative, freely rotating hubcap that can be securely mounted onto an existing wheel or hub with little modification and is properly balanced so as to insure proper rotation without wobble. Thus, a spinner hubcap solving the aforementioned problems is desired.

### SUMMARY OF THE INVENTION

The present invention is directed to a spinner hubcap. More particularly, the spinner hubcap can be installed on existing standard hubs by modifying each of the wheel studs on the standard hub to include a tapped hole that can receive a respective mounting bolt from the spinner hubcap. The spinner hubcap includes a bearing connecting it to the wheel, as well as balancing weights to ensure that it easily rotates when the wheel is in motion and that it comes to rest eventually after the wheel comes to rest.

Accordingly, the invention incorporates a spinner hubcap that is mounted onto a wheel of an automobile with a bearing and mounting bolts. The mounting bolts fit into modified wheel studs. The wheel studs are each tapped with a hole for receiving a respective mounting bolt. Balancing weights are employed to ensure that the hubcap quickly and easily rotates without wobble when the wheel rotates, and also eventually comes to rest after the wheel comes to rest. The invention provides improved elements and arrangements thereof in an apparatus for the purposes described which are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a spinner hubcap according to the present invention.

FIG. 2 is an exploded view of the spinner hubcap showing the bearing and additional support plates according to the present invention.

FIG. 2A is a partial, exploded view showing the lock washer shaft arrangement according to the present invention.

FIG. 2B is a partial sectional view of a wheel stud having internal threads.

FIG. 3 is a perspective view of a wheel having a spinner hubcap bearing mounted thereon according to the present invention.

FIG. 4 is a perspective of the spinner hubcap assembly, including the bearing and support plates, as seen from the rear side of the hubcap according to the present invention.

Similar reference characters denote corresponding features consistently throughout the attached drawings.

### DETAILED DESCRIPTION OF THE PREFERRED EMBODIMENTS

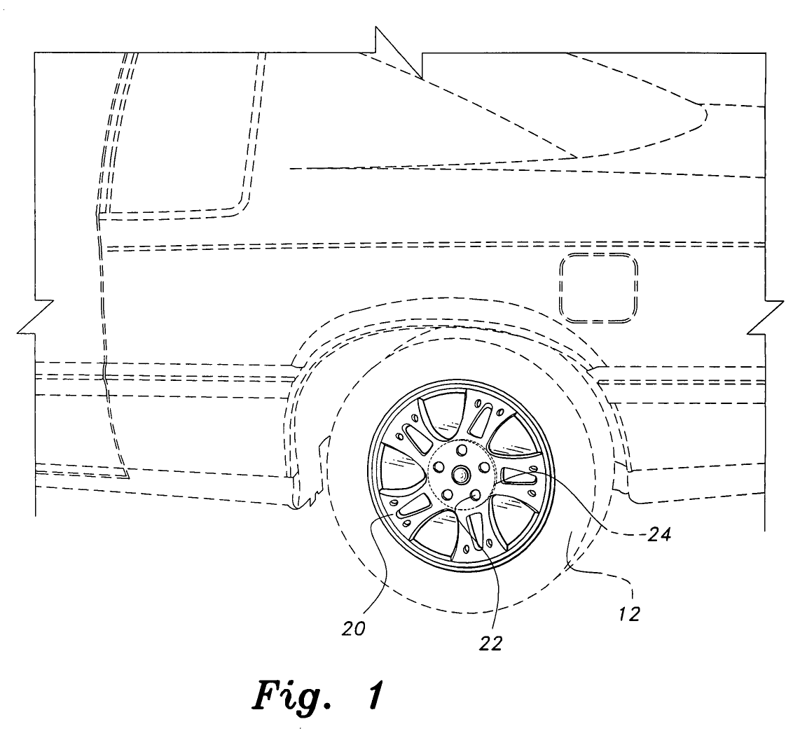

FIG. 1 shows a perspective view of a vehicle wheel and tire 12 with the spinning hubcap installed. The decorative exterior hubcap shell 20 is mounted onto an outer plate 24 of a bearing assembly by means of bolts 22.

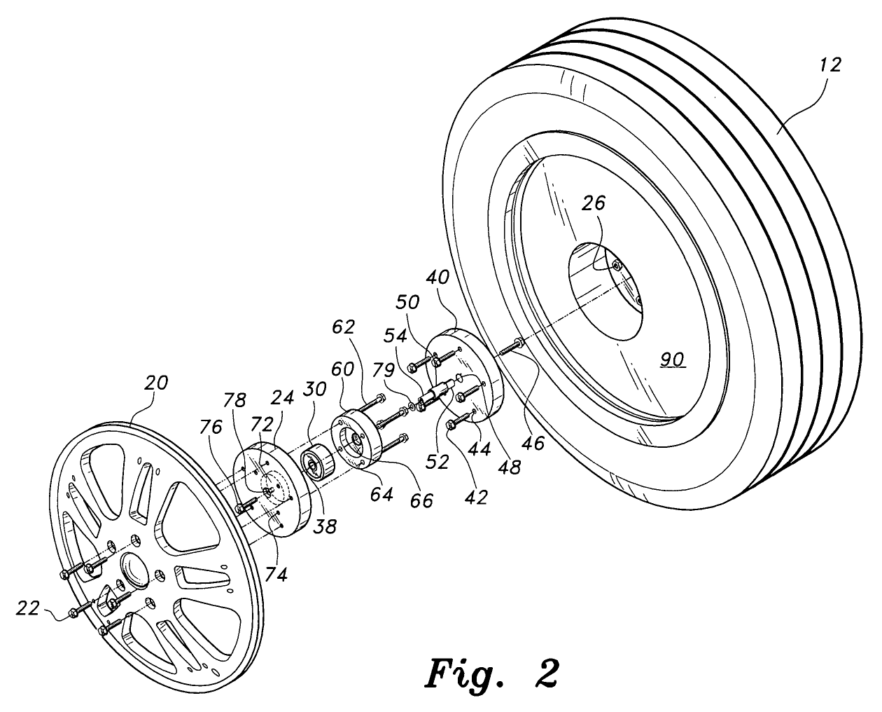

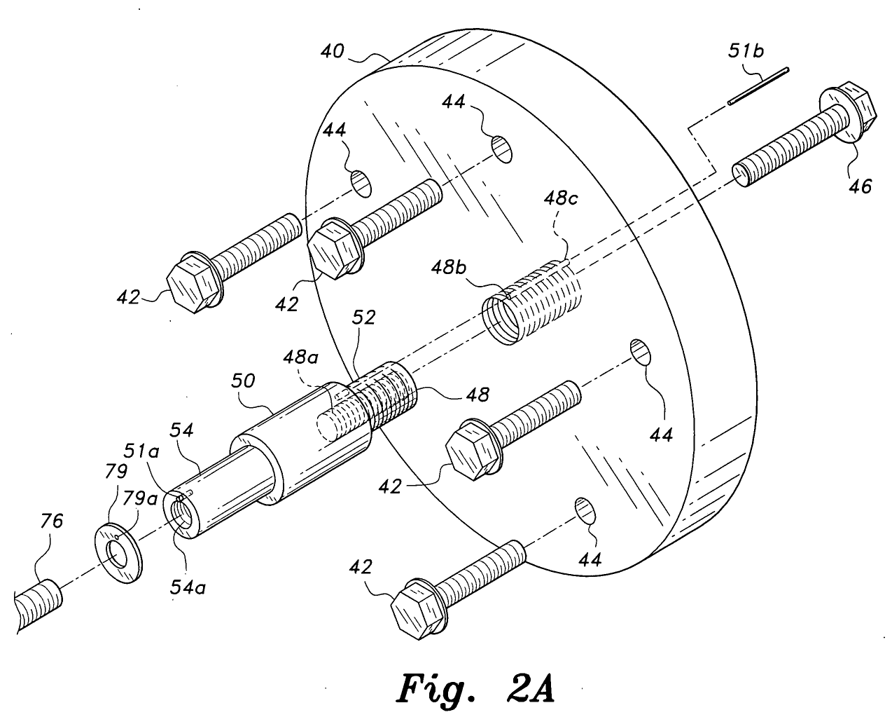

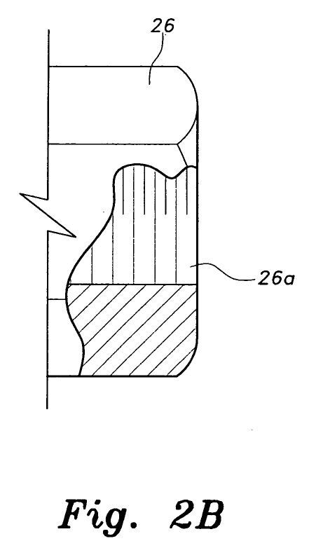

Details of the spinning hubcap assembly are best shown in FIGS. 2, 2A and 2B. The hubcap shell 20 is selected to be slightly undersized in comparison with the size of the wheel 90, i.e., by approximately one inch. For example, a fourteen-inch diameter hubcap would be used on a fifteen-inch diameter wheel.

The wheel 90 is normally mounted on wheel studs 26 which extend from the hub, and the wheel is secured by fastening lug nuts onto the studs 26. For use with the present invention, the wheel studs 26 are modified by tapping threaded hole 26a axially into the ends of the wheel studs 26 to a depth sufficient to receive mounting bolts that secure the bearing assembly to the wheel.

The bearing assembly includes a disk-shaped base plate 40 that is mounted to the wheel by bolts 42 that extend through holes 44 and are threaded into the bores defined in wheel studs 26. Shaft 50 has a smooth-faced central portion with an inner end 52 and an outer end 54 of smaller diameter than the central portion. The inner end 52 and outer end 54 are separated from the central portion by shoulders. The inner end 52 and outer end 54 of shaft 50 also have internally threaded bores 54a, 48a defined therein. The inner end 52 is externally threaded at 48 to comprise a stud. The external surface of outer end 54 is smooth. Shaft 50 is secured to base plate 40 by threading stud 52 into a threaded hole 48b defined in the center of base plate 40, and by securing the shaft 50 with bolt 46, which bolt is fastened into the internal bore defined in the stud 52. Pin 51a protrudes from outer end 54 and extends through aperture 79a defined in washer 79. Pin 51b, which is inserted after stud 52 has been threaded into hole 48b, protrudes from the shoulder of the central portion of shaft 50 and extends parallel to the threaded surface of inner end 52. Opening 48c receives pin 51b. Pins 51a and 51b further stabilize shaft 50 and prevent independent rotation.

Disk-shaped outer plate 24 has a smooth bore 78 defined through its center. Outer plate 24 is secured to the outer end 54 of shaft 50 by sliding outer plate 24 onto the outer end 54 of shaft 50, and by securing the plate to the shaft by bolt 76, which is threaded into the internally threaded bore defined in outer end 54 of shaft 50. Bolt 76 does not tighten into shaft 50 so firmly that outer plate 24 is clamped to shaft 50, but merely retains outer plate 24 on the smooth outer end 54 of shaft 50 due to its flanged head, or by a washer 79 placed under the head of the bolt 76, so that outer plate 24 rotates with bearing 30. Outer plate 24 has a cylindrical well defined therein that receives bearing 30. The bearing 30 is secured in the well by bearing retainer plate 60, which also has a cylindrical well 66 defined therein for receiving the opposite side of bearing 30. Retainer plate 60 is secured to outer plate 24 by bolts 62 which extend through holes 64 defined in the periphery of retainer plate 60 and are secured in threaded holes 74 provided in the outer plate 24 for that purpose. Bearing 30 does not rotate within the wells defined in outer plate 24 and retainer plate 60, but freely rotates about the central portion of shaft 50.

Bearing 30 is preferably a ball bearing that permits outer plate 24 to rotate freely about shaft 50 in either a clockwise or counterclockwise direction for a full 360 degrees. Hubcap shell 20 is fastened to outer plate 24 by bolts 22, which bolts engage threaded holes 72 provided in outer plate 24 so that hubcap 20 rotates with outer plate 24 about shaft 50.

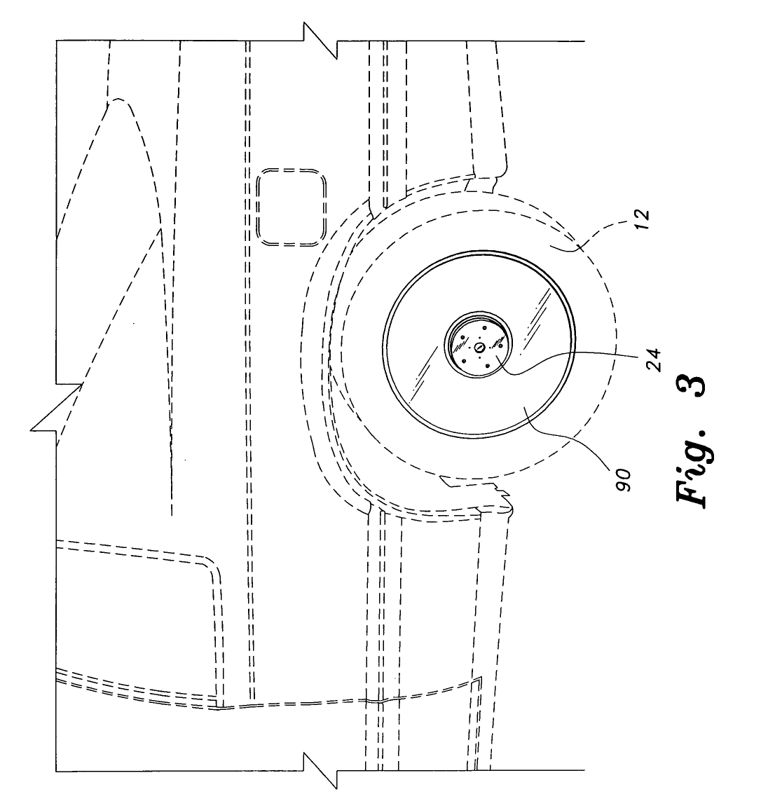

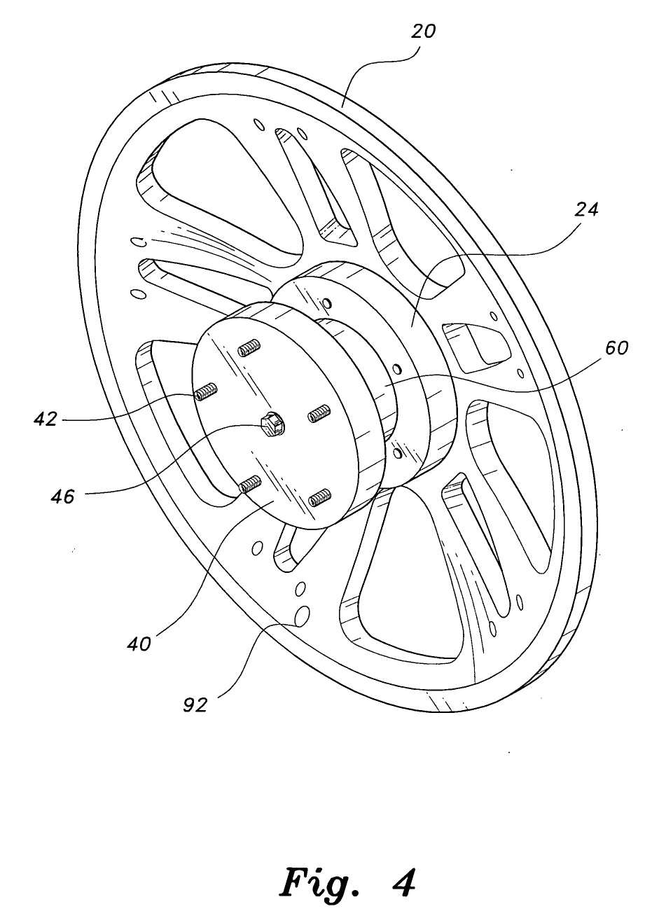

FIG. 3 shows the bearing assembly mounted on wheel 90 with hubcap shell 20 removed. FIG. 4 shows the rear side of hubcap shell 20 (the side normally facing wheel 90) with the bearing assembly attached for purposes of illustration. The drawing shows outer plate 24 adjacent hubcap shell 20, base plate 40 parallel to outer plate 24, and retainer plate 60 disposed between the outer plate 24 and base plate 40. The drawing also shows the head of bolt 46, which secures shaft 50 to base plate 40. Also seen are the ends of bolts 42, which would otherwise extend into the bores defined in wheel studs 26.

In practice, the spinner hubcap is balanced to provide for smooth rotation in much the same fashion as the wheels 90 are balanced after mounting new tires 12 on the wheels 90, i.e., by adding weights to the periphery of the hubcap shell 20. One such weight 92 is shown in FIG. 4, it being understood that a plurality of such weights may be added if required. The weights 92 may be secured to hubcap shell 20 by rivets or other appropriate fasteners. Balancing the hubcap spinner reduces friction and wear on the bearing 30.

The dimensions of the plates 40, 60, 24 and bearing 30 are selected so that they adequately fit in the corresponding opening in the wheel 90. Thus, the hubcap 20 will be capable of rotating near the rim of the wheel.

Although materials for the various parts of the spinner hubcap are preferably high strength metal, e.g., plate or cast steel, any material having suitable strength is contemplated. Alternatively, the plates 24, 40 and 60 and hubcap shell 20 may be made from a high strength aluminum alloy for lighter weight. Further, various components, for example, the hubcap shell 20, can be made from a hard plastic or composite material.

When the hubcap is adequately balanced, the hubcap 20 will rotate after sufficient rotation of the wheel 90 due to the effects of wind drag and inertia, thereby giving a visual effect of a slowly rotating wheel. Then, when the wheel 90 stops rotating, as when the vehicle comes to a stop, the hubcap 20 continues to rotate for a short period of time by inertia, thereby giving the visual effect of a wheel that continues to rotate.

It is to be understood that the present invention is not limited to the sole embodiments described above, but encompasses any and all embodiments within the scope of the following claims.

I claim:

1. A spinner hubcap for an automobile wheel, comprising:
a plurality of wheel studs adapted for attachment to the automobile wheel, each of the wheel studs having an internally threaded bore defined therein;
a base plate adapted for attachment to the automobile wheel;
a shaft having a central portion, the shaft having an inner end attached to the base plate and an opposing outer end, the inner end of the shaft having a threaded exterior surface;
an outer plate retained on the outer end of the shaft, the outer plate being free to rotate about the outer end of the shaft;
a bearing attached to the outer plate, the bearing being disposed about the central portion of the shaft; and
a hubcap shell attached to the outer plate, the outer plate and the hubcap shell rotating about the shaft in response to wind and inertia after initial rotation of the wheel, the hubcap shell rotating at a rate independent of the speed of rotation of the wheel.

2. The spinner hubcap as recited in claim 1, wherein the outer end of said shaft has a smooth exterior surface.

3. The spinner hubcap according to claim 1, further including a plurality of bolts mounting said base plate to said wheel studs.

4. The spinner hubcap according to claim 1, further including a retainer plate mounted between said base plate and said outer plate.

5. The spinner hubcap according to claim 1, wherein said hubcap shell has a plurality of openings therethrough, the spinner hubcap further including a plurality of bolts disposed through the openings for attaching said hubcap shell to said outer plate.

6. The spinner hubcap according to claim 1, further including at least one balancing weight attached to said hubcap shell.

7. A spinner hubcap for an automobile wheel, comprising:
a base plate adapted for attachment to the automobile wheel;
a shaft having a central portion, the shaft having an inner end attached to the base plate and an opposing outer end, the inner end of the shaft having a threaded exterior surface;
an outer plate retained on the outer end of the shaft, the outer plate being free to rotate about the outer end of the shaft;
a bearing attached to the outer plate, the bearing being disposed about the central portion of the shaft;
a hubcap shell attached to the outer plate, the hubcap shell having an inner surface and a plurality of openings therethrough, the hubcap shell further having a plurality of bolts disposed through the openings for attaching the hubcap shell to the outer plate; and
at least one balancing weight attached to the inner surface of the hubcap shell, the outer plate and the hubcap shell rotating about the shaft in response to wind and inertia after initial rotation of the wheel, the hubcap shell rotating at a rate independent of speed of rotation of the wheel.

8. The spinner hubcap as recited in claim 7, wherein the outer end of said shaft has a smooth exterior surface.

9. The spinner hubcap according to claim 7, further including a plurality of wheel studs adapted for attachment to the automobile wheel, each of the wheel stud having an internally threaded bore defined therein.

10. The spinner hubcap according to claim 7, further including a plurality of bolts mounting said base plate to said wheel studs.

11. The spinner hubcap according to claim 7, further including a retainer plate mounted between said base plate and said outer plate.
